(19) United States
(12) Patent Application Publication
(10) Pub. No.: US 2018/0304777 A1
(43) Pub. Date: Oct. 25, 2018

(54) SLIDING DEVICE

(71) Applicant: TOYOTA BOSHOKU KABUSHIKI KAISHA, Aichi (JP)

(72) Inventor: Sadao ITO, Aichi (JP)

(73) Assignee: TOYOTA BOSHOKU KABUSHIKI KAISHA, Aichi (JP)

(21) Appl. No.: 15/955,909

(22) Filed: Apr. 18, 2018

(30) Foreign Application Priority Data
Apr. 25, 2017 (JP) 2017-086094
Apr. 25, 2017 (JP) 2017-086095

(51) Int. Cl. B60N 2/06; F16H 25/24; B60N 2/07

(52) U.S. Cl. CPC B60N 2/067; F16H 25/24; B60N 2002/0236; F16H 2025/2445; B60N 2/0727

(57) ABSTRACT

A sliding device for supporting a seat in a slidable manner includes: a fixed rail; a movable rail; a screw rod extending along a central axis parallel to a longitudinal axis of the movable rail; a nut portion attached to the fixed rail such that the nut portion is limited in displacement along the longitudinal axis relative to the fixed rail; a first support portion supporting one end of an extension axis of the screw rod in a rotatable manner such that the first support portion limits the one end from moving along the longitudinal axis; and a second support portion supporting the other end of the extension axis of the screw rod in a rotatable manner such that the second support portion limits the other end from moving beyond a predetermined length along the longitudinal axis.

### CROSS-REFERENCE TO RELATED APPLICATIONS

This international application claims the benefit of Japanese Patent Application No. 2017-86094 and Japanese Patent Application No. 2017-86095, which were filed on Apr. 25, 2017 with the Japan Patent Office, and the entire disclosures of Japanese Patent Application No. 2017-86094 and Japanese Patent Application No. 2017-86095 are incorporated herein by reference.

### BACKGROUND

The present disclosure relates to a sliding device that supports a seat in a slidable manner.

For example, a sliding device described in Japanese Unexamined Patent Application Publication No. 2008-80997 (Patent Document 1) comprises a fixed rail, a movable rail, a screw rod, and a nut portion. The screw rod extending parallel to a longitudinal axis of the movable rail (and of the fixed rail) is rotary-driven by an electric motor. The nut portion engaging the screw rod remains immovable relative to the fixed rail along a longitudinal axis and an up-down axis thereof.

### SUMMARY

When directional force that makes the screw rod compressed or expanded (hereinafter referred to as thrust load) is applied to the screw rod, a failure of the sliding device may occur. Therefore, it is desirable that one aspect of the present disclosure provides a sliding device that can inhibit a failure from occurring.

A sliding device comprises: a fixed rail; a movable rail that is mounted to the fixed rail in a slidable manner, and is configured for mounting the seat; a screw rod extending along a central axis parallel to a longitudinal axis of the movable rail; a nut portion engaging the screw rod, the nut portion being indirectly attached to the fixed rail such that the nut portion is limited in displacement along the longitudinal axis relative to the fixed rail; a first support portion supporting one end of an extension axis of the screw rod in a rotatable manner such that the first support portion limits the one end from moving along the longitudinal axis; and a second support portion supporting the other end of the extension axis of the screw rod in a rotatable manner such that the second support portion limits the other end from moving beyond a predetermined length (hereinafter referred to as a margin length) along the longitudinal axis.

In such a manner, when thrust load is applied to the screw rod, the thrust load can be absorbed in the margin length.

When the thrust load that is so large to cause the screw rod to move beyond the margin length is applied to the screw rod, forces of such thrust load can be shared by the first support portion and the second support portion.

Accordingly, even when the large thrust load is applied to the screw rod, large flexural deformation can be inhibited from occurring in the screw rod. Further, a failure of the sliding device can be inhibited from occurring.

The sliding device may be configured in the following manner.

It is desirable that the second support portion comprise: a block portion comprising a through-hole that the screw rod passes through, the block portion being fixed to the movable rail; a cylindrical portion in a cylindrical shape, that is inserted in the through-hole and through which the screw rod passes, the cylindrical portion threadedly engaging the other end of the extension axis of the screw rod; a first limit portion that is disposed at the one end of the axis of the cylindrical portion, the first limit portion being configured with a surface that is orthogonal to the longitudinal axis and opposed to the one end; and a second limit portion disposed at the other end of the axis of the cylindrical portion, the second limit portion being configured with a surface opposed to an outer wall of the block portion.

In such a manner, a designer of the sliding device can easily set the aforementioned margin length by selecting an axial length of the cylindrical portion.

It is desirable that one axis of two different axes orthogonal to the longitudinal axis be referred to as a first axis and that an outer dimension of a portion parallel to the first axis in the block portion be equal to or greater than an outer dimension of a portion parallel to the longitudinal axis in the block portion.

This allows support strength of the second support portion to be higher than that of Patent Document 1, so that large flexural deformation of the screw rod can be inhibited from occurring.

For example, the sliding device described in the specification of U.S. Pat. No. 5,711,184 comprises a fixed rail, a movable rail, a screw rod, a nut portion, and so forth. The screw rod extending along a longitudinal axis of the movable rail is rotary-driven by an electric motor. The nut portion engages the screw rod and remains immovable relative to the fixed rail along a longitudinal axis and an up-down axis thereof.

Since the nut portion disclosed in the specification of U.S. Pat. No. 5,711,184 remains immovable along the up-down axis relative to the fixed rail, when flexural deformation of the screw rod occurs vertically or when vertical load causes flexural deformation of the screw rod vertically, a failure of the sliding device may occur.

The screw rod may rotate in response to rotational force. The screw rod may be fixed to the movable rail such that the screw rod is supported by the movable rail in a rotatable manner. The nut portion may comprise, at both ends thereof, two flat-surface portions substantially orthogonal to the longitudinal axis. The sliding device may comprise a storage block portion, the storage block portion being fixed to the fixed rail, the storage block portion comprising two contact surfaces that are slidingly contactable with the two flat-surface portions respectively, the storage block portion being provided with a storage portion storing the nut portion in a displaceable manner along two axes, which are different from each other, orthogonal to the longitudinal axis.

In such a manner, force of the longitudinal axis, which is caused by rotation of the screw rod, is applied to the movable rail when either one of the flat-surface portions comes in contact with either one of the contact surfaces. Accordingly, when the screw rod rotates, the movable rail is displaced by sliding.

Within the storage portion, the nut portion is displaceable along the two different axes orthogonal to the longitudinal axis.

For this reason, when flexural deformation of the screw rod occurs vertically or even when vertical load causes flexural deformation of the screw rod vertically, such flexural deformation can be absorbed by displacement of the nut portion within the storage portion. Eventually, a failure of the sliding device can be inhibited from occurring.

The sliding device may be configured in the following manner.

It is desirable that the storage block portion be fixed to the fixed rail with a plurality of fasteners and the plurality of fasteners be lined up along the longitudinal axis. In such a manner, the storage block portion is strongly fixed to the fixed rail. This can inhibit a failure from occurring in the sliding device.

In case of the sliding device described in Patent Document 1, the nut portion is rotatable about an up-down axis as a central axis. For this reason, fixing strength between the nut portion and the fixed rail in the sliding device described in Patent Document 1 is lower than that in the sliding device of the present disclosure.

It is desirable that one axis of the aforementioned two different axes be referred to as a first axis and that a dimension of a portion parallel to the first axis in the two contact surfaces be equal to or greater than a diameter of the screw rod. This can inhibit contact-surface pressure of the respective contact surfaces from increasing excessively, thereby improving endurance of the sliding device.

### BRIEF DESCRIPTION OF THE DRAWINGS

Hereinafter, example embodiments of the present disclosure will be described with reference to the accompanying drawings, in which:

FIG. 1 is a drawing of a vehicle seat;

FIG. 2 is a perspective view of a sliding device;

FIG. 3 is an exploded perspective view of the sliding device;

FIG. 4 is a sectional view of the sliding device, taken along a longitudinal axis thereof;

FIG. 5 is a sectional view of a first support portion;

FIG. 6 is a sectional view of a second support portion;

FIG. 7 is an enlarged view of a storage block portion and a nut portion;

FIG. 8 is an exploded view of the storage block portion and the nut portion;

FIG. 9A is a perspective view of the first support block portion; and

FIG. 9B is a perspective view of the second support block portion.

### DETAILED DESCRIPTION OF THE PREFERRED EMBODIMENTS

“Embodiments” to be described below are example embodiments of the present disclosure. Invention-specifying-matters and so forth recited in the accompanying claims are not limited to specific configurations, structures, and the like, shown in the below-described embodiments.

Arrows and so forth that indicate directions shown in the drawings are provided for easy understanding of mutual relationships between the drawings. The present disclosure is not limited by such directions shown in the drawings.

1. Overview of Sliding Device

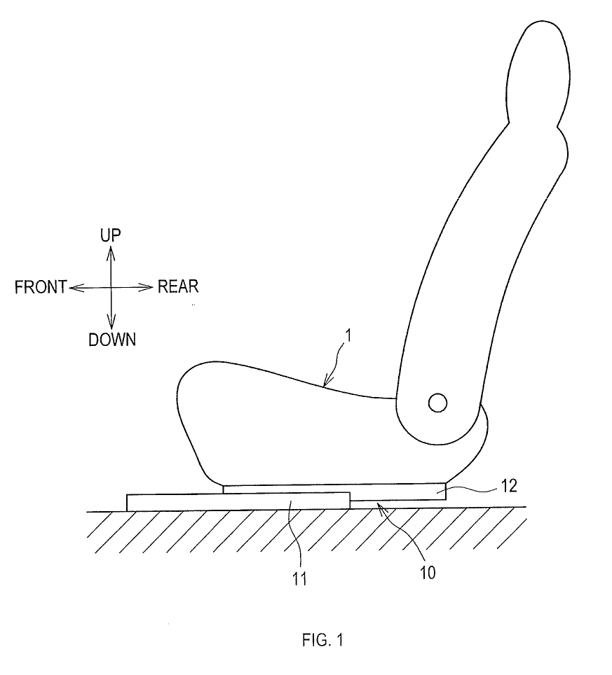

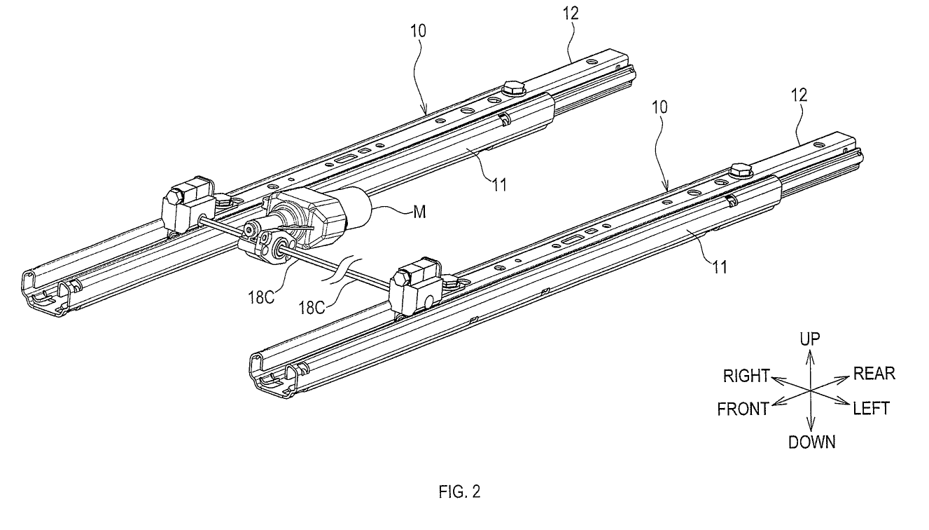

As shown in FIG. 1, a sliding device 10 of the present disclosure is disposed below a vehicle seat 1 for supporting the vehicle seat 1. Sliding devices 10 (two in the present embodiment) support the vehicle seat 1 (see FIG. 2).

One of the sliding devices 10 disposed at one end of the vehicle seat land the other sliding device 10 is disposed at the other end of the vehicle seat 1. These sliding devices 10 have substantially mirror image structures. Hereinafter, the structure and so forth of the sliding device 10 disposed at the one end of the vehicle seat 1 (left end of the vehicle seat 1) will be described.

2. Structure of Sliding Device

<Sliding Device>

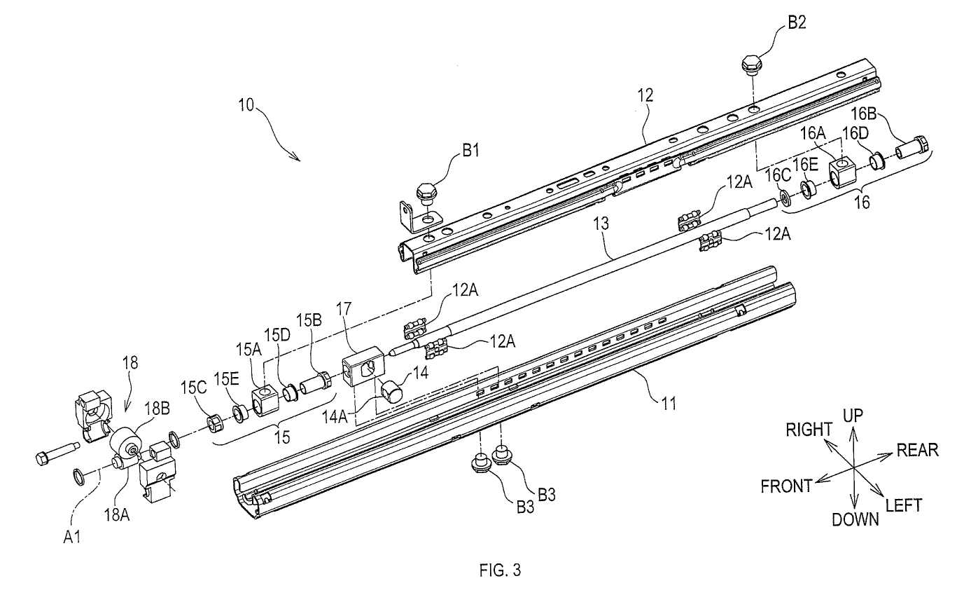

As shown in FIG. 3, the sliding device 10 comprises a fixed rail 11 and a movable rail 12. The fixed rail 11 is preferably fixed onto a vehicle side with a leg bracket (not shown) and so forth.

The movable rail 12 is a member mounted to the fixed rail 11 in a slidable manner. The movable rail 12 is supported by a plurality of rolling elements 12A. The plurality of rolling elements 12A can roll to contact the movable rail 12 and the fixed rail 11. Accordingly, the movable rail 12 can be displaced (horizontally in a longitudinal direction) by sliding relative to the fixed rail 11.

The vehicle seat 1 is fixed onto the movable rail 12. Thus, the vehicle seat 1 together with the movable rail 12 is displaced along an axis parallel to a longitudinal axis of the fixed rail 11. In the present embodiment, the longitudinal axis of the fixed rail 11 is consistent with a seat-front-rear axis.

A screw rod 13 is a rod-like member that extends along an axis parallel to a longitudinal axis of the movable rail 12 and rotates in response to rotational force from an electric motor M (see FIG. 2) via a shaft 18C. The screw rod 13 is fixed to the movable rail 12 such that the screw rod 13 is supported by the movable rail 12 in a rotatable manner.

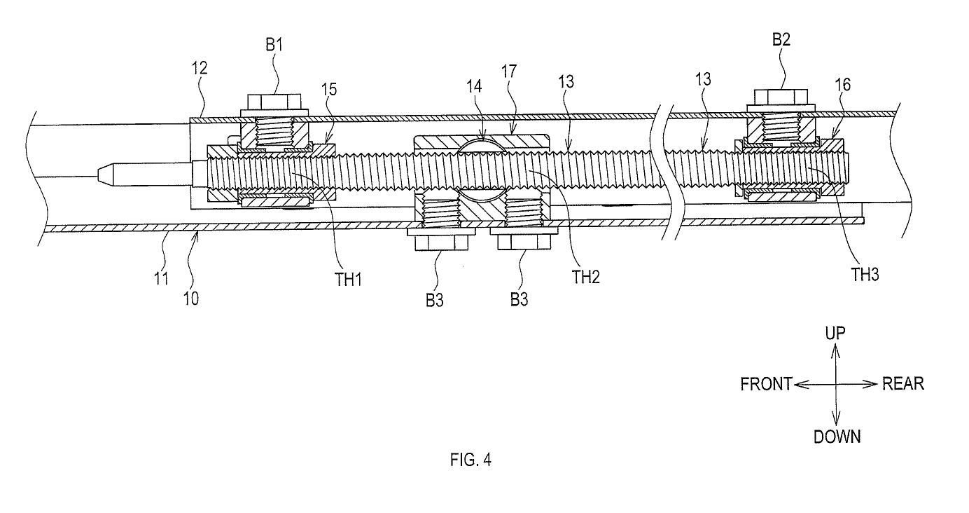

In other words, the screw rod 13 can rotate about a central axis A1 thereof, although a relative position of the screw rod 13 with respect to the movable rail 12 is maintained. Specifically, a first support portion 15 and a second support portion 16 are disposed at both ends of an extension axis of the screw rod 13 respectively as shown in FIG. 4.

The first support portion 15 supports one end (on a seat-front side in the present embodiment) of the extension axis of the screw rod 13. The second support portion 16 supports the other end (on a seat-rear side in the present embodiment) of the extension axis of the screw rod 13.

<First Support Portion>

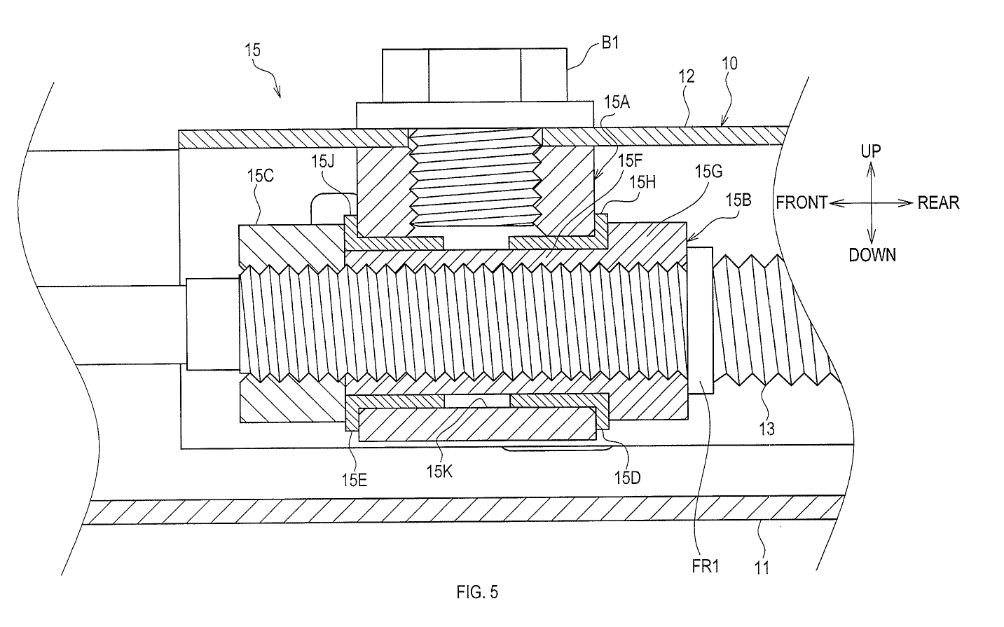

As shown in FIG. 5, the first support portion 15 comprises a first support block portion 15A, a first bearing nut 15B, a first nut 15C, and bushings 15D and 15E. The first support block portion 15A is a metal member comprising a through-hole 15K that the screw rod 13 passes through.

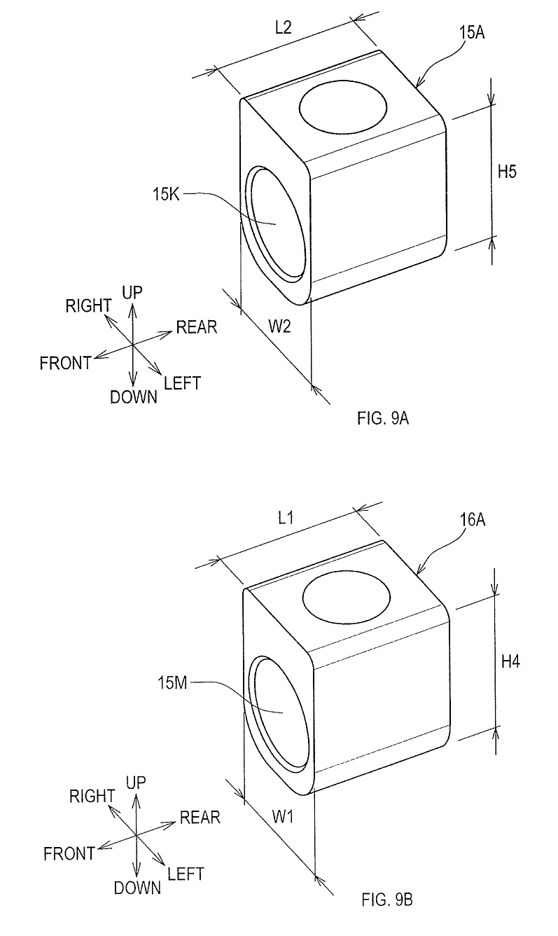

The first support block portion 15A is fixed to the movable rail 12 with a first bolt B1. An up-down size (hereinafter referred to as a height) H5 (see FIG. 9A) of the first support block portion 15A and a right-left size (hereinafter referred to as a width) W2 (see FIG. 9A) thereof are preferably equal to or greater than a front-rear size (hereinafter referred to as a length) L2 (see FIG. 9A) of the first support block portion 15A. In other words, preferably H5≥L2, and preferably W2≥L2.

The first bearing nut 15B comprises a cylindrical portion 15F in a cylindrical shape and a nut portion 15G. An inner circumferential surface of the cylindrical portion 15F is provided with a front female thread arranged for receiving a front male thread TH1 (external thread) arranged on a front portion of the screw rod 13. An outer circumferential surface of the cylindrical portion 15F is directly or indirectly (through the bushings 15E and 15D) in sliding-contact with an inner circumferential surface of the through-hole 15K of the first support block portion 15A.

That is, a radial bearing portion allowing the screw rod 13 to be supported in a rotatable manner is configured with the cylindrical portion 15F, the bushings 15D and 15E, and the inner circumferential surface of the through-hole 15K of the first support block portion 15A. The nut portion 15G has an outer dimension that is greater than an outer dimension of the cylindrical portion 15F.

The cylindrical portion 15F and the nut portion 15G are preferably integrated together as a single part. An outer shape of the nut portion 15G is formed to be a shape allowing a fastener tool (for example, an open-end wrench) to be attachable thereto. For example, the shape has at least two opposing flat surfaces (e.g. a hexagon or the like).

The first nut 15C is disposed on an opposite side of the nut portion 15G, with the first support block portion 15A located therebetween. The first nut 15C engages the front male thread TH1 arranged at the screw rod 13. Thus, the first bearing nut 15B and the first nut 15C may be tightened against each other, and rotate integrally with the screw rod 13.

The bushings 15D and 15E are formed of a material whose friction coefficient is small, such as resin, brass, or the like. A guard portion 15H (also known as a flange portion) of the bushing 15D is fixed to the first support block portion 15A such that the guard portion 15H is placed between the nut portion 15G and the first support block portion 15A.

The guard portion 15J of the bushing 15E is fixed to the first support block portion 15A such that the guard portion 15J is placed between the first nut 15C and the first support block portion 15A. In such a manner, the guard portions 15H and 15J function as a thrust bearing.

Therefore, the first nut 15C and the nut portion 15G each function as a limit portion that limits the one end of the extension axis of the screw rod 13 from moving along the axis parallel to the longitudinal axis of the movable rail 12. The guard portion 15H as well as the guard portion 15J are flange-like portions projecting radially outward from a bushing main body that is formed to be cylindrical. The bushing main bodies and the corresponding guard portions 15H or 15J are preferably each an integrally molded part. Alternately, a single bushing with two flanges may be substituted. Alternately, a cylindrical bushing and two washer bushings may be substituted.

<Second Support Portion>

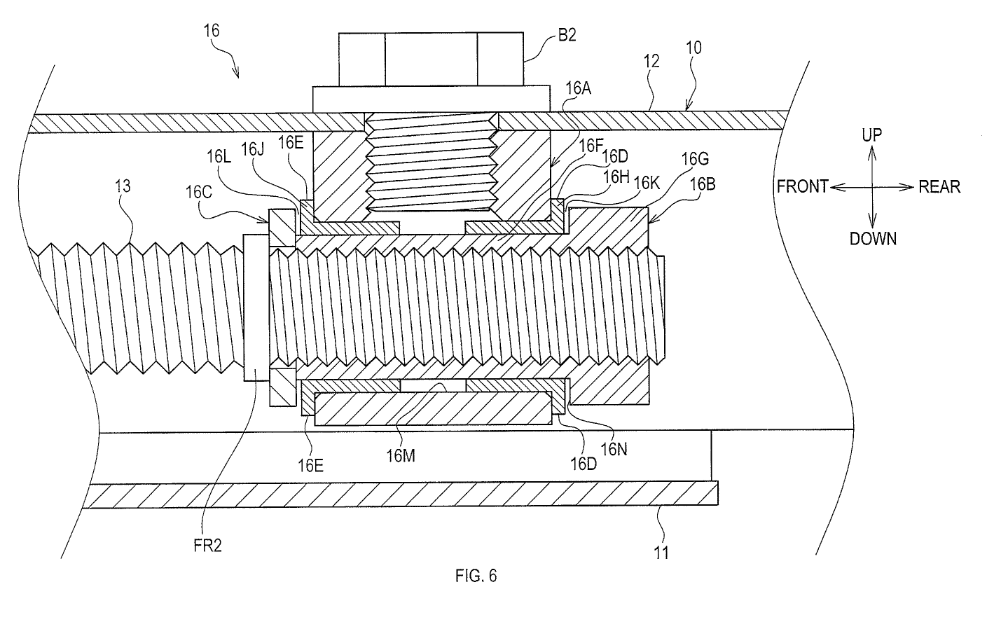

As shown in FIG. 6, the second support portion 16 comprises at least a second support block portion 16A, a second bearing nut 16B, a flat washer 16C, bushings 16D and 16E, and so forth. The second support block portion 16A is preferably a metal member comprising a through-hole 16M that the screw rod 13 passes through.

The second support block portion 16A is fixed to the movable rail 12 with a second bolt B2. A height H4 (see FIG. 9B) of the second support block portion 16A and a width W1 (see FIG. 9B) thereof are equal to or greater than a length L1 (see FIG. 9B) of the second support block portion 16A.

The second bearing nut 16B comprises a cylindrical portion 16F in a cylindrical shape and a nut portion 16G. An inner circumferential surface of the cylindrical portion 16F is provided with a female thread arranged for engaging a rear male TH3 thread arranged at a rear portion of the screw rod 13. That is, the screw rod 13 passes through an inside of the cylindrical portion 16F so as to be integrated with the cylindrical portion 16F, namely, the second bearing nut 16B.

An outer circumferential surface of the cylindrical portion 16F is indirectly in sliding-contact with an inner circumferential surface of a through-hole 16M of the second support block portion 16A with the bushinges 16D and 16E therebetween. Accordingly, a radial bearing portion allowing the screw rod 13 to be supported in a rotatable manner is configured with the cylindrical portion 16F, the bushings 16D and 16E, and the inner circumferential surface of the through-hole 16M of the second support block portion 16A.

Relative to the second support block portion 16A disposed at one end of an axis of the cylindrical portion 16F. The nut portion 16G has an outer dimension greater than an outer dimension of the cylindrical portion 16F. The nut portion 16G has a surface 16N that is indirectly opposed to an outer wall surface of the second support block portion 16A with a guard portion 16H therebetween.

The cylindrical portion 16F and the nut portion 16G are preferably integrated together. An outer shape of the nut portion 16G is formed to be a shape allowing a fastener tool to be attachable thereto, for example a hexagon.

A flat washer 16C is disposed on an opposite side of the nut portion 16G, in other words, at the one end of the axis of the cylindrical portion 16F, with the second support block portion 16A therebetween. The flat washer 16C is opposed to an end surface of the cylindrical portion 16F at the one end of the axis thereof, and in press-contact with such an end surface so that the flat washer 16C rotates integrally with the screw rod 13.

The bushings 16D and 16E are formed of a material whose friction coefficient is small, such as resin, brass, or the like. The guard portion 16H as well as a guard portion 16J is a flange-like portion projecting radially outward from a bushing main body. The bushing main body and the corresponding guard portion 16H as well as the bushing main body and the corresponding guard portion 16J are an integrally molded part.

A space 16K is arranged between the guard portion 16H and the nut portion 16G. A space 16J is arranged between the guard portion 16J and the flat washer 16C. In other words, the nut portion 16G- and the flat washer 16C are separated from the second support block portion 16A.

In such a manner, the nut portion 16G and the flat washer 16C each function as a limit portion that limits the other end of the extension axis of the screw rod 13 from moving beyond a predetermined length along the axis parallel to the longitudinal axis of the movable rail 12.

<Nut Portion and Storage Block Portion>

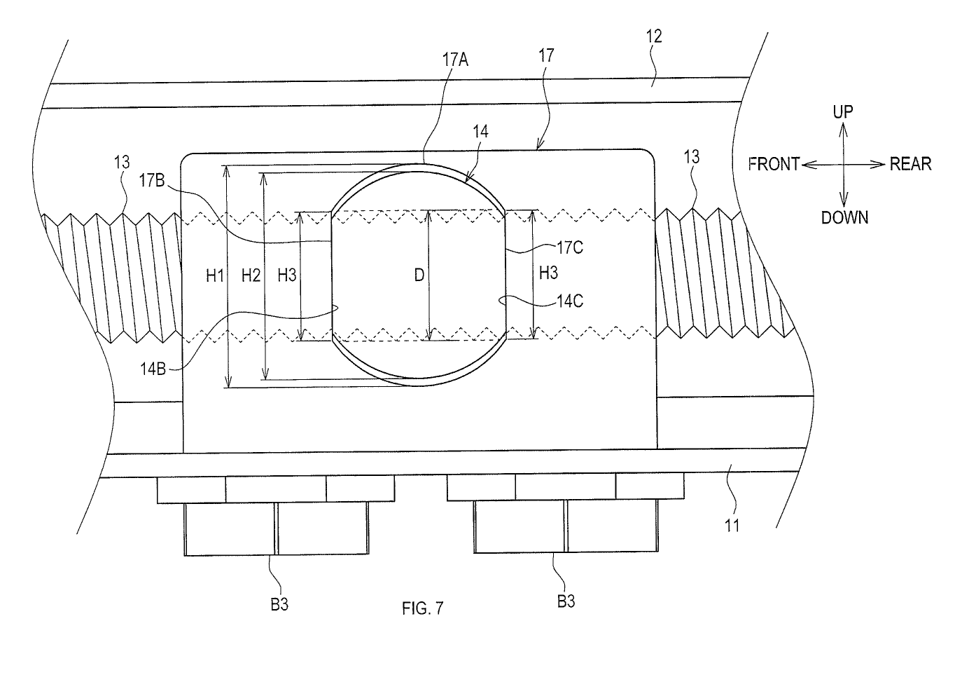

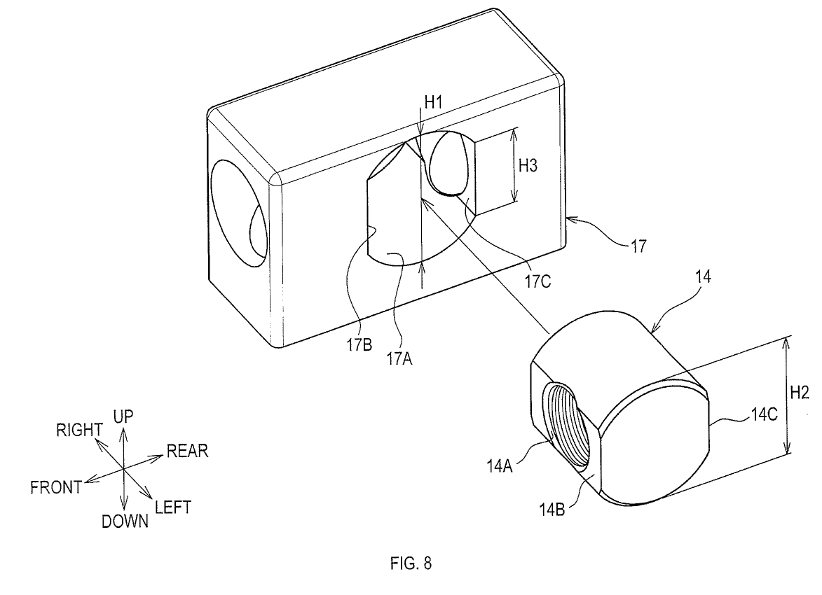

An outer circumferential surface of the screw rod 13 is provided with a center male thread TH2. The center male thread TH2 may have more threads per centimeter than the front male thread TH1 and more than the rear male thread TH3. A nut portion 14 shown in FIG. 7 has a through-hole 14A that the screw rod 13 passes through (see FIG. 8). An inner circumferential surface of such a through-hole 14A is provided with a center female thread for engaging the center male thread TH2 of the screw rod 13.

Thread pitches of parts of the male threads, which engage the first bearing nut 15B (front male thread TH1) and the second bearing nut 16B (rear male thread TH3), are smaller than a thread pitch of a part (center male thread TH2) that engages the nut portion 14. The small thread pitches are to inhibit the first bearing nut 15B, the second bearing nut 16B, and the first nut 15C from becoming loose. In contrast, the purpose of the large center male thread TH2 is to rotate relative to the nut portion 14 and to drive/move the screw rod 13 transversely relative to the nut portion 14 (and thus move the movable rail 12 relative to the fixed rail 11).

A pass-through axis of the through-hole 14A is coaxial with (and thus identical with) the central axis A1 of the screw rod 13, specifically, coaxial with the longitudinal axis of the movable rail 12.

In FIG. 8, flat-surface portions 14B and 14C that are substantially orthogonal to a central axis of the nut portion 14 are disposed at front and rear ends respectively of the nut portion 14. As shown in FIG. 7, the nut portion 14 is stored in a storage block portion 17 that is preferably made of metal.

A storage portion 17A for storing the nut portion 14 comprises contact surfaces 17B and 17C that are opposed to the flat-surface portions 14B and 14C respectively. The contact surfaces 17B and 17C each can be in sliding-contact with the corresponding flat-surface portions 14B and 14C:

In such a manner, the nut portion 14 stored in the storage portion 17A can be displaced within the storage portion 17A along two different axes orthogonal to the pass-through axis. In other words, the nut portion 14 can be displaced within the storage portion 17A vertically and in a left-right direction. This potential slight displacement absorbs some dimensional inaccuracies while driving the screw longitudinally forward or backwards.

Specifically, a height H1 of the storage portion 17A is greater than a height H2 of the nut portion 14. Also, the storage portion 17A is a hollow penetrating the storage block portion 17 along a horizontal axis (left-right axis or seat width axis) orthogonal to the central axis. Thus, the nut portion 14 can be displaced slightly vertically and slightly left-right during operation.

Heights H3 of the contact surfaces 17B and 17C are equal to or greater than a diameter D of the center male threads TH2 of the screw rod 13. In the present embodiment, widths that are orthogonal to the pass-through axis of the screw rod 13 in the contact surfaces 17B and 17C are also equal to or greater than the diameter D of the screw rod 13.

The storage block portion 17 is fixed to the fixed rail 11. The storage block portion 17 according to the present embodiment is fixed to the fixed rail 11 with one or more fasteners (in the present embodiment, two bolts B3). The fasteners B3 are disposed in series along the central axis (in the present embodiment, the seat-front-rear axis).

<Drive Portion>

A drive portion 18 shown in FIG. 3 transmits to the screw rod 13 rotational force transmitted from an electric motor M. The drive portion 18 is configured with a worm 18A, a worm wheel 18B, and so forth. The rotational force of the electric motor M is supplied to the worm wheel 18B of the respective sliding devices 10 via a shaft 18C as shown in FIG. 2.

3. Features of Sliding Device according Present Embodiment

The second support portion 16 supports the rear of the central axis of the screw rod 13 in a rotatable manner such that the second support portion 16 limits the other end of the extension axis of the screw rod 13 from moving beyond the predetermined length (hereinafter referred to as a margin length LM) along the longitudinal axis of the movable rail 12.

In such a manner, when thrust load is applied to the screw rod 13, the thrust load can be absorbed in the margin length LM. The margin length LM corresponds to lengths of the spaces 16K and 16L.

Moreover, when the thrust load that is so large to cause the screw rod 13 to move beyond the margin length is supplied to the screw rod 13, force of such thrust load can be shared by the first support portion 15 and the second support portion 16.

Accordingly, even when the large thrust load is applied to the screw rod 13, large flexural deformation can be inhibited from occurring in the screw rod 13. Further, a failure of the sliding device can be inhibited from occurring.

The flat washer 16C disposed at the one end of the axis of the cylindrical portion 16F (forward of the cylindrical portion 16F) is opposed to and in press-contact with the one end of the axis of the cylindrical portion 16F (a front surface of the cylindrical portion 16F). The nut portion 16G disposed at the rear end of the cylindrical portion 16F comprises the surface 16N that is opposed to the rear outer wall surface of the second support block portion 16A.

In such a manner, a designer of the sliding device 10 can easily set the aforementioned margin length LM by selecting a length of the cylindrical portion 16F, and/or by selecting a length of the second supporting block portion 16A.

The height H4 and the width W1 of the second support block portion 16A are equal to or greater than the length L1 of the second support block portion 16A. In such a manner, since support strength of the second support portion 16 is higher than that of Patent Document 1, large flexural deformation of the screw rod 13 can be inhibited from occurring.

The nut portion 14 comprises the flat-surface portions 14B and 14C, which are substantially orthogonal to the central axis of the nut portion 14. The storage portion 17A stores the nut portion 14 such that the nut portion 14 is slightly displaceable vertically in a left-right direction. Also, the storage portion 17A comprises the contact surfaces 17B and 17C that can be in sliding-contact with the flat-surface portions 14B and 14C respectively.

In such a manner, longitudinal forces caused by rotation of the screw rod 13 are applied to the movable rail 12 when either one of the flat-surface portions 14B and 14C comes in contact with either one of the contact surfaces 17B and 17C.

In other words, when the screw rod 13 rotates so that the nut portion 14 is displaced toward the seat-front side relative to the movable rail 12 (forward), the flat-surface portion 14B and the contact surface 17B come in press-contact with each other. At that time, since the storage block portion 17 is fixed to the fixed rail 11 and the screw rod 13 cannot be displaced along the pass-through axis relative to the movable rail 12, the movable rail 12 is displaced toward the seat-rear side. In other words, the screw rod 13 (and the indirectly attached movable rail 12) is displaced/driven rearward.

Oppositely, when the screw rod 13 rotates so that the nut portion 14 is displaced toward the seat-rear side relative to the movable rail 12, the flat-surface portion 14C and the contact surface 17C come in press-contact with each other. Thus, in contrast to the aforementioned case, the movable rail 12 is displaced toward the seat-front side (displaced/driven forward.).

As previously discussed, the nut portion 14 is slightly displaceable along the two different axes orthogonal to the central axis.

For this reason, when flexural deformation of the screw rod 13 occurs vertically or even when vertical load causes flexural deformation of the screw rod 13 vertically, such flexural deformation can be absorbed by displacement of the nut portion 14 within the storage portion 17A. Thus, a failure of the sliding device 10 can be inhibited from occurring.

The storage block portion 17 is fixed to the fixed rail 11 with the fasteners B3, and the fasteners B3 are lined up along the central axis. In such a manner, the storage block portion 17 is strongly fixed to the fixed rail 11. This can inhibit failure from occurring in the sliding device.

With respect to the contact surfaces 17B and 17C, at least the heights H3 thereof are equal to or greater than the diameter D of the screw rod 13. In such a manner, contact-surface pressure of the respective contact surfaces 17B and 17C can be inhibited from increasing excessively. This can improve endurance of the sliding device 10.

### OTHER EMBODIMENTS

The nut portion 14 and the storage portion 17A according to the above-described embodiment are configured with arc-like curved surfaces on an upper side and a lower side (as shown in FIG. 8). However, the present disclosure is not limited by such a configuration. Specifically, for example, the nut portion 14 and the storage portion 17A may be configured with flat surfaces parallel to the pass-through axis on the upper side and the lower side.

The storage block portion 17 according to the above-described embodiment is fixed to the fixed rail 11 with the bolts B3. However, the present disclosure is not limited by such a configuration. Specifically, for example, fixation to the fixed rail 11 may be conducted with only one bolt B3.

In the above-described embodiment, the height H4 of the second support block portion 16A and the width W1 thereof are equal to or greater than the length 11 of the second support block portion 16A. However, the present disclosure is not be limited by such a configuration.

In the above-described embodiment, the bushings 15D, 15E, 16D, and 16E are disposed. However, the present disclosure is not limited by such a configuration. For example, the bushings 15D, 15E, 16D, and 16E may not be disposed, and may or may not have flanges.

In the above-described embodiment, with respect to the contact surfaces 17B and 17C, at least the heights H3 thereof are equal to or greater than the diameter D of the screw rod 13 (center male threads TH2). However, the present disclosure is not limited by such a configuration.

In the above-described embodiment, the sliding device 10 according to the present disclosure is applied to a vehicle seat. However, the present disclosure is not limited by such an application. The present disclosure can be applied to a seat of a train car, a ship, an aircraft, and other conveyances as well as to a stationary seat in a theater, at home, and so forth.

Moreover, in the present disclosure, at least two of a plurality of the above-described embodiments may be combined.

What is claimed is:

1. A sliding device for supporting a seat in a slidable manner, the sliding device comprising:
a fixed rail;
a movable rail that is mounted to the fixed rail in a slidable manner, and is configured for mounting the seat.
a screw rod extending along a central axis parallel to a longitudinal axis of the movable rail;
a nut portion engaging the screw rod, the nut portion being attached to the fixed rail such that the nut portion is limited in displacement along the longitudinal axis relative to the fixed rail;
a first support portion supporting one end of an extension axis of the screw rod in a rotatable manner such that the first support portion limits the one end from moving along the longitudinal axis; and
a second support portion supporting the other end of the extension axis of the screw rod in a rotatable manner such that the second support portion limits the other end from moving beyond a predetermined length along the longitudinal axis.

2. The sliding device according to claim 1,
wherein the second support portion comprises:
a block portion comprising a through-hole that the screw rod passes through, the block portion being fixed to the movable rail;
a cylindrical portion in a cylindrical shape that is inserted in the through-hole and through which the screw rod passes, the cylindrical portion threadedly engaging the other end of the extension axis of the screw rod;
a first limit portion disposed at one end of an axis of the cylindrical portion, the first limit portion being configured with a surface orthogonal to the longitudinal axis and opposed to the one end; and
a second limit portion disposed at the other end of the axis of the cylindrical portion, the second limit portion being configured with a surface opposed to an outer wall of the block portion.

3. The sliding device according to claim 1,
wherein one axis of two different axes orthogonal to the longitudinal axis is a first axis, and an outer dimension of a portion parallel to the first axis in the block portion is equal to or greater than an outer dimension of a portion parallel to the longitudinal axis in the block portion.

4. The sliding device according to claim 1,
wherein the screw rod rotates in response to rotational force, the screw rod being fixed to the movable rail such that the screw rod is supported by the movable rail in a rotatable manner,
wherein the nut portion comprises, at both ends thereof, two flat-surface portions substantially orthogonal to the longitudinal axis, and
wherein the sliding device comprises a storage block portion, the storage block portion being fixed to the fixed rail, the storage block portion comprising two contact surfaces that are slidingly contactable with the two flat-surface portions respectively, the storage block portion being provided with a storage portion storing the nut portion in a displaceable manner along two axes, which are different from each other, orthogonal to the longitudinal axis.

5. The sliding device according to claim 4,
wherein the storage block portion is fixed to the fixed rail with a plurality of fasteners, and
wherein the plurality of fasteners are lined up along the longitudinal axis.

6. The sliding device according to claim 4,
wherein one axis of the two axes is referred to as a first axis, and a dimension of a portion parallel to the first axis in the two contact surfaces is equal to or greater than a diameter of the screw rod.
